(19) United States
(12) Patent Application Publication
(10) Pub. No.: US 2007/0074222 A1
(43) Pub. Date: Mar. 29, 2007

(54) Thread scheduling apparatus, systems, and methods

(75) Inventor: Aaron Kunze, Portland, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/235,960

(22) Filed: Sep. 27, 2005

(51) Int. Cl. G06F 9/46

(52) U.S. Cl. 718/107

(57) ABSTRACT

Apparatus and systems, as well as methods and articles, may operate to determine the number of mutexes held by a thread during a quantum time period, including a rescheduling window time period. One embodiment includes a system having a processor coupled to a computer-readable medium, a data structure in the computer-readable medium to associate a quantum time with one of a plurality of threads, and a detection module responsive to the processor to determine the number of mutexes held by the one thread during the quantum time. Other embodiments are described and claimed.

### TECHNICAL FIELD

Various embodiments described herein relate to data processing generally, including apparatus, systems, and methods used to schedule threads in a multi-threaded operating system.

### BACKGROUND INFORMATION

Some operating system schedulers associate a “quantum,” or permitted execution time interval, with each thread of execution, or “thread” in a system. These schedulers may adjust the thread quantum size based on the thread priority or behavior. When such systems have threads that utilize mutexes (mutual exclusion semaphore variables used to lock/unlock shared resources) for synchronization, it may happen that thread execution will be pre-empted at the same time that particular thread has acquired a mutex to lock a resource. This may cause unnecessary work for the scheduler as it searches for a thread to run next on the same hardware context (core, processor, hardware thread, etc.). On other hardware contexts in a system with multiple hardware contexts, this may cause threads to forfeit the remainder of their quantum when they try to acquire the same mutex. If these situations arise repeatedly, the performance of the system may be reduced significantly as a result of unnecessary scheduler overhead and increased contention for mutexes.

### BRIEF DESCRIPTION OF THE DRAWINGS

FIG. 1A illustrates thread rescheduling operations according to various embodiments of the invention.

FIG. 1B is a block diagram of a system according to various embodiments of the invention.

FIG. 2 includes flow diagrams illustrating several methods according to various embodiments of the invention.

FIG. 3 is a block diagram of an article according to various embodiments of the invention.

### DETAILED DESCRIPTION

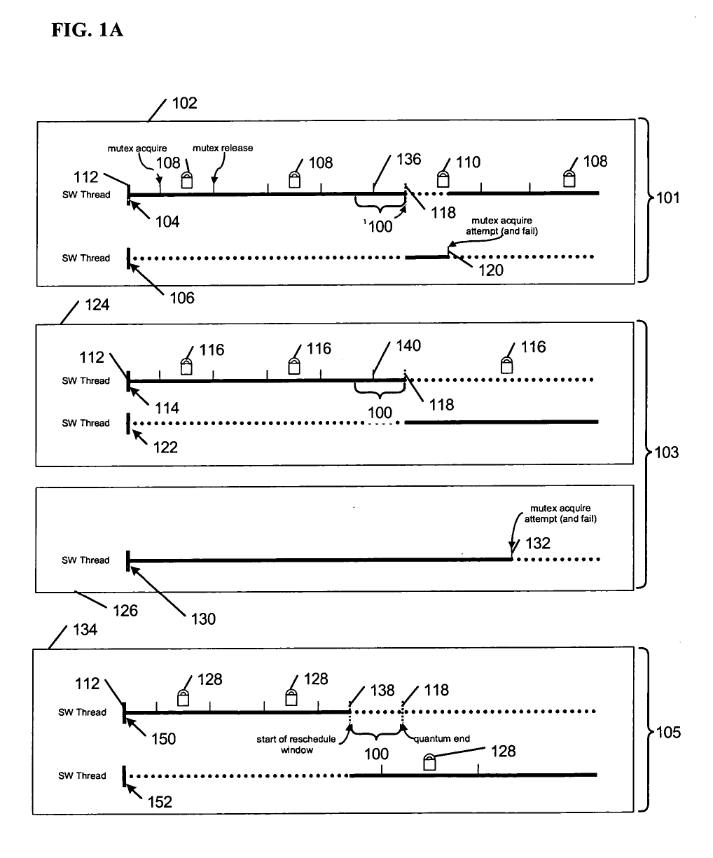

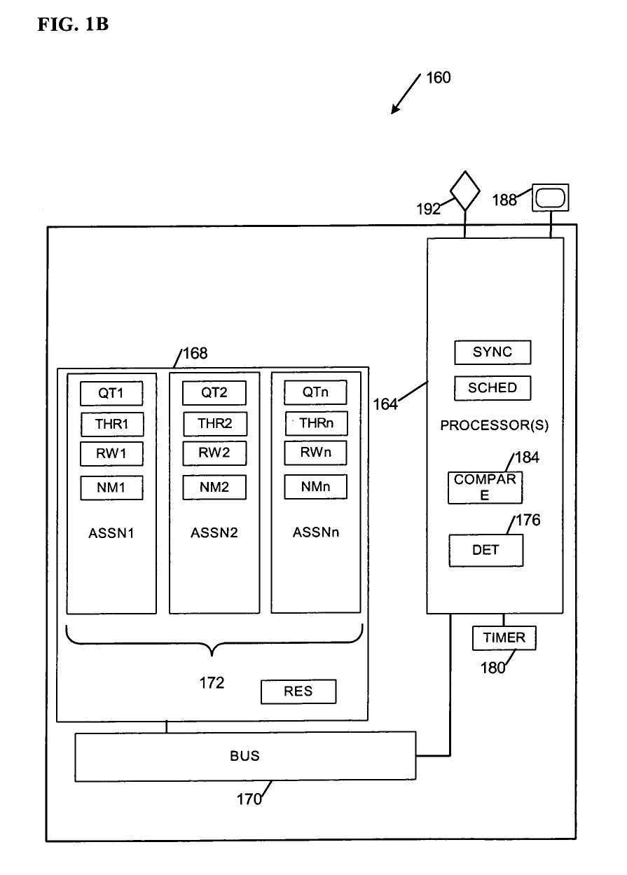

FIG. 1A illustrates thread rescheduling operations according to various embodiments of the invention. Three scenarios 101, 103, 105 are shown, any one or more of which may execute on a single processing platform, or divided up among multiple platforms/processors, at substantially the same time, or at different times. In some embodiments, a “reschedule window” 100, meaning a period of time before the quantum of a thread expires, may be defined for selected threads (e.g., threads 104, 114, and 150). The reschedule window 100 may form some fractional portion of the quantum time (starting at the quantum beginning 112, and terminating at the quantum ending 118). During the reschedule window 100 time period (e.g., in thread 150, beginning at time 138, and ending at a time substantially coinciding with the quantum ending 118, for example), if a thread enters a state in which no mutexes are held, or a state in which less than some selected number of mutexes are held, the thread may be rescheduled.

Thus, considering thread 150 as an example, if this mechanism is used, the probability that the thread 150 will be rescheduled while it holds a mutex 128 (or a significant number of mutexes) is reduced. Therefore, if thread 152 (which may be located in a different hardware context than thread 150, instead of in the same hardware context 134 shown in FIG. 1A) attempts to acquire the mutex 128, the probability that thread 152 will be successful in its acquisition is increased.

For the purposes of this document, a “hardware context” 102, 124, 126, and 134 can be considered to comprise any hardware instruction sequencer. For example, a processor core with symmetrical multithreading implemented in hardware has one hardware context per hardware thread. Likewise a chip with two of these cores could have twice as many hardware contexts. And a shared-memory multiprocessor system with two of these dual-core chips would have yet again twice as many hardware contexts as a single dual-core chip.

For example, in the scenario 101 comprising hardware context 102, thread 104 may begin executing during its assigned quantum that begins at the quantum beginning 112 and ends at the quantum ending 118. In a system using a quantum-based pre-emptive scheduler, when a timer interrupt occurs and the quantum of the currently-executing thread has expired, the operating system may place the thread in a run queue and schedule a different thread for execution. This type of scheduling may ensure that threads having work to do will make progress within the application execution environment.

If the threads in a system make liberal use of mutexes for synchronization, it is sometimes the case that a thread will be pre-empted when it owns a mutex. For example, one or more mutexes 108 may be acquired and released during the quantum assigned to thread 104. If thread 104 has acquired a mutex 110 prior to the time thread 106 is scheduled to run (e.g., the thread 104 acquires the mutex 110 at time 136 and continues ownership outside the quantum period because no rescheduling occurs prior to time 136 during the reschedule window 100), and thread 106 begins execution and attempts to acquire the same mutex 110 at time 120, then thread 106 will likely be rescheduled since it cannot make progress until thread 104 releases the mutex 110. This can unnecessarily increase the frequency at which the scheduler runs, increasing in turn, the system overhead.

On systems with multiple hardware contexts 124, 126, shown in scenario 103, such as multi-threaded, multi-core, and/or multi-processor systems, pre-empting a thread while it owns a mutex can cause performance loss for another reason. For example, if a thread 114 in a first hardware context 124 is pre-empted by a second thread 122 while it owns a mutex 116 (e.g., mutex 116 is acquired at time 140), without prior rescheduling during the reschedule window 100, and a thread 130 on another hardware context 126 is waiting for the same mutex 116 at time 132, the waiting thread 130 may unnecessarily have to wait for the thread 114 holding the mutex 116 (and perhaps thread 122) to be rescheduled and release the mutex 116.

Various embodiments of the invention may enable the resolution of both illustrated issues. For example, if the reschedule window 100 is defined, and threads 104, 114, or 150 enter a state in which no mutexes are held, or relatively few mutexes are held, while running in the time period of the reschedule window, the threads 104, 114, and 150 may be rescheduled. If this occurs, the probability that a thread will be rescheduled while holding a mutex (or a significant number of mutexes) can be reduced. The overhead caused by frequent running of the scheduler, and contention for mutexes between hardware contexts may then decrease.

Some embodiments can be implemented via the scheduling and synchronization components of an operating system. For example, operating systems can maintain a data structure for each thread in the system, and the data structure may include a time value indicating when a thread's quantum is due to expire. If a system timer interrupt occurs and the value of this field indicates the currently-executing thread's quantum has expired (e.g., the value indicates a time in the past), then the scheduler may go on to schedule the next thread.

FIG. 1B is a block diagram of a system 160 according to various embodiments of the invention. In some embodiments, a system 160 may include one or more processors 164 coupled to a computer-readable medium 168, such as a memory, perhaps directly, or indirectly, via a bus 170 or some other mechanism (e.g., a network or cache memory). The system 160 may also include a data structure 172 in the computer-readable medium 168 to associate a plurality of quantum times QT1, QT2, . . . , QTn with a corresponding plurality of threads THR1, THR2, . . . , THRn. The correspondence may be a one-to-one correspondence, or a many-to-one correspondence (e.g., each thread may be associated with one, or more than one, quantum time as application execution progresses). The associations may be made in a variety of ways known to those of ordinary skill in the art, including via the use of one or more look-up association tables ASSN1, ASSN2, . . . , ASSNn.

In some embodiments, a scheduler program SCHED may be executed by the processor(s) 164. The scheduler SCHED may operate to load and unload threads THR1, THR2, . . . , THRn in response to receiving timer interrupts from the timer 180. The scheduler SCHED itself may also be loaded and unloaded, and may be stored in the computer-readable medium 168. The computer-readable medium 168 may also include a shared resource RES, which may be locked and unlocked by mutexes owned by the threads THR1, THR2, . . . , THRn.

The system 160 may include a detection module 176 responsive to the processor(s) 164 to determine a number of mutexes held NM1, NM2, . . . , NMn by any one or more of the plurality of threads during the quantum time periods QT1, QT2, . . . , QTn. In some embodiments, the detection module 176 may also be used to determine whether one of the plurality of threads (e.g., THRn) is executing during a quantum time, and/or the rescheduling window time (e.g., RWn) that forms a portion of a selected quantum time (e.g., QTn).

A variety of fields may be added to the data structure 172. For example, a field may be used to indicate when a particular thread's reschedule window begins, and can be computed at the same time as the computation occurs to determine the end of the quantum. Thus, the data structure 172 may also associate a plurality of reschedule window times RW1, RW2, . . . , RWn with a corresponding plurality of threads THR1, THR2, . . . , THRn. Again, the correspondence may be a one-to-one correspondence, or a many-to-one correspondence. Thus, each thread may be associated with a single reschedule window time, or multiple reschedule window times as application execution progresses. Another field may be used to indicate how many mutexes any given thread currently holds, perhaps maintained by the synchronization component SYNC of the operating system. Thus, the data structure 172 may also associate a plurality of number of mutexes held values NM1, NM2, . . . , NMn with a corresponding plurality of threads THR1, THR2, . . . , THRn.

Therefore, in some embodiments of the system 160, the data structure 172 may be used to associate a rescheduling window time (e.g., RWn) with a quantum time (e.g., QTn) and one of a plurality of threads (e.g., THRn). The data structure 172 may also be used to associate the number of mutexes held (e.g., NMn) with a rescheduling window time (e.g., RWn) and one of a plurality of threads (e.g., THRn). Other associations are possible.

Rescheduling window times may be fixed or variable, perhaps adjusted in response to a variety of operating system conditions, or the behavior of selected threads. If the rescheduling window time is fixed, it may be set to some fraction of the associated quantum, such as less than about 50%, 25%, or 10% of the quantum time. However, in some embodiments, the rescheduling window time associated with a particular thread may form a variable portion of the associated quantum time, so as to occupy about 25% of the quantum time, and then grow incrementally in five percent increments toward about 50% of the quantum time in some cases, or to decrease in five percent increments down to about 5% of the quantum time in others.

When an operating system timer interrupt occurs, perhaps in response to a timer 180 coupled to the processor(s) 164, the values of the fields RWn, NMn can be used to determine that the currently-executing thread THRn is operating within the reschedule window time period, and at the same time, that the thread is holding no mutexes (or less than some selected number of mutexes), for example. If this is the case, the thread THRn may be rescheduled. Also, when a thread THRn releases a mutex, the synchronization component SYNC may notify the scheduler SCHED, and if the currently-executing thread THRn is operating in the reschedule window defined by RWn, and the thread is holding no mutexes (or less than some selected number of mutexes), as indicated by the number of mutexes held field NMn, then the thread THRn may be rescheduled.

In some embodiments, the system 160 may include a comparison module 184 coupled to the processor(s) 164 to compare the number of mutexes held (e.g., NM1) by one of a plurality of threads (e.g., THR1) with a number of mutexes held (e.g., NM2) by another one (e.g., THR2) of the plurality of threads. It should be noted that the detection module 176 and the comparison module 184, as well as the synchronization component and scheduler modules SYNC, SCHED may be located within the processors 164 (as shown in FIG. 1B), or outside the processors 164. Similarly, the timer 180, which is shown outside the processors 164 may also be located within the processors 164. The comparison module 184, as well as the synchronization component and scheduler modules SYNC, SCHED, and the timer 180 may comprise hardware, software, firmware, or combinations of these.

Several variations may be considered. For example, assigning a reschedule window only to threads that use, or are predicted to use, a minimum number of mutexes might reduce the overhead of the associated rescheduling operations. Also, determining or predicting that a particular thread may acquire several mutexes at the same time, and then rescheduling such multi-mutex threads when it is determined that they hold no mutexes (or less than a certain number of mutexes) may improve system performance. Thus the processor(s) 164 and/or scheduler module SCHED may operate to reschedule a thread if less than some threshold number of mutexes are held by the thread during a rescheduling window time, for example.

Other embodiments may be realized. For example, a system 160 may include one or more displays 188, including cathode ray tube displays, flat panel displays, and others, to display data (e.g., any of the elements THRn, QTn, RWn, and NMn) stored in the computer-readable medium 168. The system 160 may also include an antenna 192, such as an omnidirectional, dipole, patch, or beam antenna, coupled to the processor 164.

Any of the components previously described can be implemented in a number of ways, including simulation via software. Thus, the reschedule window 100; hardware contexts 102, 124, 126, 134; threads 104, 106, 114, 122, 130, 150, 152; mutexes 108, 110, 116, 124, 128; quantum beginning 112; quantum end 118; times 120, 132, 136, 138, 140; systems 160; processors 164; computer-readable medium 168; bus 170; data structure 172; detection module 176; timer 180; comparison module 184; displays 188; antenna 192; association tables ASSN1, ASSN2, . . . , ASSNn; number of mutexes held values NM1, NM2, . . . , NMn; quantum times QT1, QT2, . . . , QTn; shared resource RES; reschedule window times RW1, RW2, . . . , RWn; and threads THR1, THR2, . . . , THRn may all be characterized as “modules” herein. The modules may include hardware circuitry, single or multi-processor circuits, memory circuits, software program modules and objects, firmware, and combinations thereof, as desired by the architect of the systems 160 and as appropriate for particular implementations of various embodiments. The modules may be included in a system operation simulation package such as a software electrical signal simulation package, a power usage and distribution simulation package, a network security simulation package, a power/heat dissipation simulation package, a signal transmission-reception simulation package, or any combination of software and hardware used to simulate the operation of various potential embodiments. Such simulations may be used to characterize or test the embodiments, for example.

It should also be understood that the apparatus and systems of various embodiments can be used in applications other than rescheduling threads in single and multiples hardware contexts. Thus, various embodiments of the invention are not to be so limited. The illustrations of systems 160 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, and application-specific modules, including multilayer, multi-chip modules. Such apparatus and systems may further be included as sub-components within a variety of electronic systems, such as data bridges, switches, and hubs; televisions and cellular telephones; personal computers and workstations; radios and video players; and vehicles, among others.

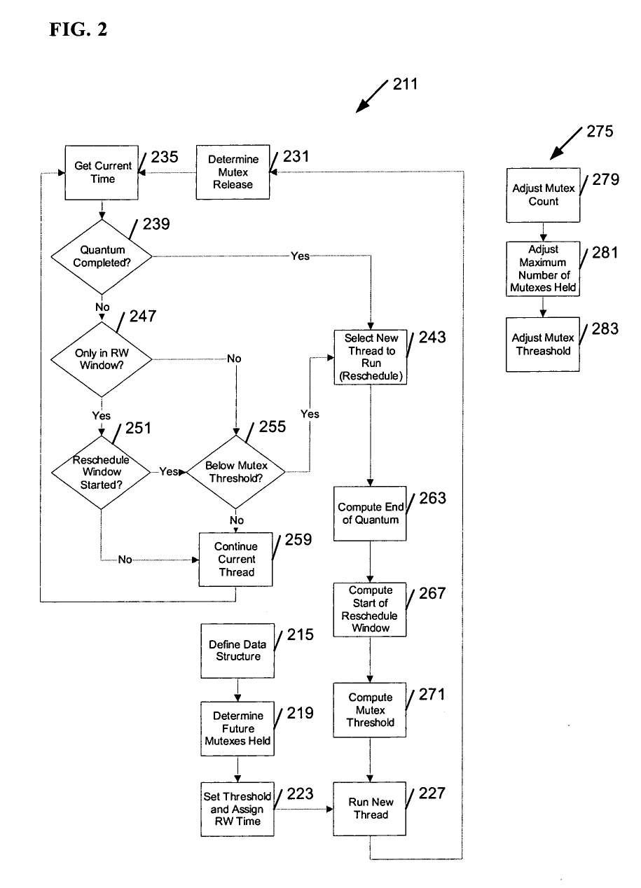

Some embodiments may include a number of methods. For example, FIG. 2 includes flow diagrams illustrating several methods 211, 275 according to various embodiments of the invention. Method 211 may be executed in response to the occurrence of a timer interrupt, and at other selected times, such as prior to the execution of any thread. The method 211 may begin at block 215 with defining and/or utilizing a data structure, including utilizing a data structure to associate one or more threads with a quantum time, a rescheduling window time, and/or a number of mutexes held, either currently, or in the future. The method 211 may continue at block 219 with determining that the threads will hold at least a threshold number of mutexes at a future time. This determination may be based on the number of mutexes some threads have held in the past.

In some embodiments, the method 211 may include, at block 223, setting a threshold number of mutexes based on a number of mutexes a selected thread has concurrently held at a previous time, or perhaps based on the number of mutexes determined (or predicted) to be held by the thread at a future time. The threshold number of mutexes may be set to any number, including a variable number or a fixed number, such as one, two, three, four, or five, for example.

In some embodiments, the method 211 at block 223 may also include assigning a rescheduling window time to the thread. The end of the rescheduling window time period associated with the thread may be set so as to substantially coincide with the end of the associated quantum time, such that the reschedule window time forms some fraction of the quantum time.

At block 227, the method 211 may include executing one or more threads—including those threads that have been assigned associated reschedule window times, and those threads that do not. In some embodiments, the method 211 may also include determining that the thread has released a one or more mutexes at block 231. At blocks 235 and 239, the method 211 may include obtaining the current time and determining that a selected thread is executing within its quantum time, respectively. If the thread has completed its quantum time, a new thread may be selected for execution at block at block 243.

If the selected thread is executing within its quantum time as determined at block 239, then the method 211 may continue with determining whether rescheduling is to occur only within the reschedule window at block 247. If so, then the method 211 may continue with block 251. If rescheduling may occur at other times within the quantum time, then the method 211 may continue with determining the number of mutexes held by the thread during the quantum time, and perhaps storing a value indicating the number of mutexes held in a memory. In some embodiments, this activity may be followed by determining whether the number of mutexes held is less than a selected threshold number of mutexes at block 255. If the number of mutexes held is not less than the selected threshold, the method 211 may continue with executing the thread at block 259

Thus, in some embodiments, the method 211 may continue on to block 251 with determining whether the thread is executing within a rescheduling window time (forming a portion of the quantum time). If not, then the method 211 may continue with executing the thread at block 259.

If it is determined that the thread is executing within a selected rescheduling window time at block 251, then the method 211 may include determining the number of mutexes held by the thread during the rescheduling window time, and perhaps storing a value indicating the number of mutexes held in a memory. The method 211 may continue, in some embodiments, with determining whether the number of mutexes held is less than a selected threshold number of mutexes at block 255. If the number of mutexes held is not less than the selected threshold, the method 211 may continue with executing the thread at block 259.

If the number of mutexes held is less than the selected threshold, as determined at block 255, the method 211 may continue with rescheduling the thread at block 243 by selecting a new thread to run. Thus, the method 211 may include comparing the number of mutexes held by the thread to a threshold number of mutexes at block 255. Rescheduling at block 243 may occur if the number of mutexes held, during the quantum time, and/or during the rescheduling window time, is less than a threshold number selected at block 223.

When a new thread is selected to run at block 243, the method 211 may include computing the end of the quantum time associated with the new thread at block 263, computing the start of a reschedule window assigned to the new thread at block 267, and/or computing a threshold number of mutexes held at block 271. The method 211 may include continuing on to block 227.

Method 275 may be executed when a mutex is locked or unlocked by an executing thread. Thus, method 275 may include adjusting a mutex count at block 279, including increasing the number of mutexes held when a mutex is locked, and decreasing the number of mutexes held when a mutex is unlocked.

The method 275 may continue with adjusting a maximum number of mutexes held by a thread at block 281, such as when a selected thread holds a number of mutexes that exceeds all prior or predicted maximum counts of mutexes held. The method 275 may also include adjusting (and re-adjusting) a mutex threshold at block 283, perhaps in response to an adjusted maximum number of mutexes held, the number of mutexes held over a selected time period, or the number of mutexes held according to some statistical measure of execution performance over several applications.

The methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

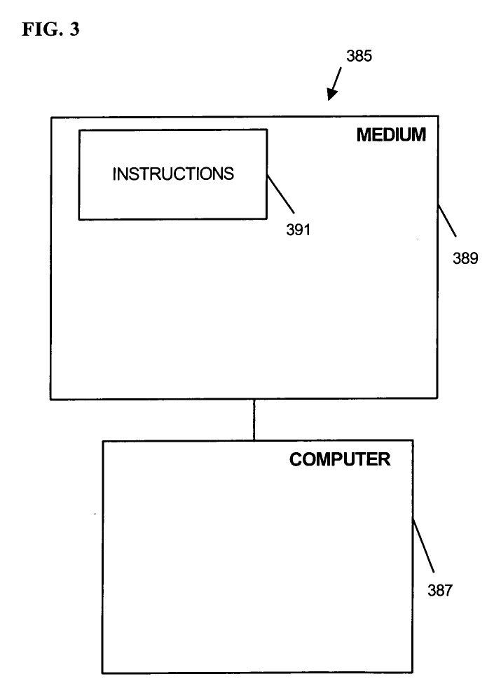

Thus, other embodiments may be realized. For example, FIG. 3 is a block diagram of an article 385 according to various embodiments, such as a computer, a memory system, a magnetic or optical disk, some other storage device, and/or any type of electronic device or system. The article 385 may include a computer 387 (having one or more processors) coupled to a computer-readable medium 389, such as a memory (e.g., fixed and removable storage media, including tangible memory having electrical, optical, or electromagnetic conductors) or a carrier wave, having associated information 391 (e.g., computer program instructions and/or data), which when executed by the computer 387, causes the computer 387 to perform a method including determining that a thread is executing within a quantum time and determining the number of mutexes held by the thread during the quantum time.

Other activities may include determining that the thread is executing within a rescheduling window time (forming a portion of the quantum time), and determining the number of mutexes held by the thread during the rescheduling window time. Further activities may include utilizing a data structure to associate the thread with the quantum time and the rescheduling window time, as well as comparing the number of mutexes held by the thread to a threshold number of mutexes. Other activities may include any of those forming a portion of the methods illustrated in FIG. 2 and described above.

Implementing the apparatus, systems, and methods disclosed herein may operate to improve the overall utilization of embedded systems, among others. Improvements may occur due lowered scheduling overhead, and/or reducing the number of failed attempts to gain mutex ownership.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A system, including:
a processor coupled to a computer-readable medium;
a data structure in the computer-readable medium to associate a first quantum time with a first one of a plurality of threads; and
a detection module responsive to the processor to determine a number of mutexes held by the first one of the plurality of threads during the first quantum time.

2. The system of claim 1, wherein the data structure is to associate a first rescheduling window time with the first quantum time and the first one of the plurality of threads.

3. The system of claim 2, wherein the data structure is to associate the number of mutexes held by the first one of the plurality of threads with the first rescheduling window time.

4. The system of claim 1, wherein the detection module is to determine whether the first one of the plurality of threads is executing during a first rescheduling window time forming a portion of the first quantum time.

5. The system of claim 1, wherein the data structure is to associate a second quantum time and a second rescheduling window time with a second one of the plurality of threads.

6. The system of claim 1, further including:
a comparison module coupled to the processor to compare the number of mutexes held by the first one of the plurality of threads with a number of mutexes held by a second one of the plurality of threads.

7. The system of claim 1, wherein a rescheduling window time associated with the first one of the plurality of threads forms a variable portion of the first quantum time.

8. The system of claim 1, wherein the processor is to reschedule the first one of the plurality of threads if less than a threshold number of mutexes are held by the first one of the plurality of threads during a rescheduling window time.

9. A method, including:
determining that a thread is executing within a quantum time; and
determining a number of mutexes held by the thread during the quantum time.

10. The method of claim 9, further including:
determining the number of mutexes held by the thread during a rescheduling window time forming a portion of the quantum time.

11. The method of claim 10, further including:
rescheduling the thread if less than a threshold number of mutexes are held by the thread during the rescheduling window time.

12. The method of claim 9, further including:
setting a threshold number of mutexes based on a number of mutexes the thread has concurrently held at a previous time.

13. The method of claim 9, further including:
setting a threshold number of mutexes to one of one, two, three, four, or five, wherein the threshold number is based on a number of mutexes the thread has concurrently held at a previous time.

14. The method of claim 9, wherein an end of a rescheduling window time period associated with the thread substantially coincides with an end of the quantum time.

15. The method of claim 9, further including:
determining that the thread will hold at least a threshold number of mutexes at a future time; and
assigning a rescheduling window time to the thread.

16. The method of claim 9, further including:
determining that the thread has released a single mutex.

17. The method of claim 9, further including:
storing a value indicating the number of mutexes in a computer-readable medium.

18. A computer-readable medium having instructions stored thereon which, when executed by a computer, cause the computer to perform a method comprising:
determining that a thread is executing within a quantum time; and
determining a number of mutexes held by the thread during the quantum time.

19. The computer-readable medium of claim 18, wherein the instructions, when executed by the computer, cause the computer to perform a method comprising:
determining that the thread is executing within a rescheduling window time forming a portion of the quantum time; and
determining a number of mutexes held by the thread during the rescheduling window time.

20. The computer-readable medium of claim 18, wherein the instructions, when executed by the computer, cause the computer to perform a method comprising:
utilizing a data structure to associate the thread with the quantum time and the rescheduling window time.

21. The computer-readable medium of claim 18, wherein the instructions, when executed by the computer, cause the computer to perform a method comprising:
comparing the number of mutexes held by the thread to a threshold number of mutexes.

22. The computer-readable medium of claim 18, wherein the instructions, when executed by the computer, cause the computer to perform a method comprising:
rescheduling the thread if less than a threshold number of mutexes are held by the thread during a rescheduling window time.
